(19) United States
(12) Patent Application Publication
(10) Pub. No.: US 2012/0089424 A1
(43) Pub. Date: Apr. 12, 2012

(54) TRAVEL INFORMATION SYSTEM

(75) Inventor: Ernst Von WEYHAUSEN, Road Town (VG)

(73) Assignee: Allmyflights Limited, Road Town (VG)

(21) Appl. No.: 12/900,432

(22) Filed: Oct. 7, 2010

(51) Int. Cl. G06Q 10/00; G06Q 30/00; G06F 3/048; G01C 21/00

(52) U.S. Cl. 705/5; 705/14.49; 715/764

(57) ABSTRACT

An electronic travel booking system is disclosed, wherein the booking system is configured to display locations of interest on an electronic map. An input analysis module 30 is configured to determine the position of a movable pointer 58 on a map, and a calculation module 28 is configured to identify any locations of interest within an area defined at least in part by the determined position of the movable pointer 58. Any locations of interest that are identified are marked 60 on the map so that they can be viewed and selected by a user as a point of origin or destination. A flight determination module 24 is arranged to determine a number of flights that match a user's requirements and these results are plotted on a graph 140 by a plotting module 106.

The present invention relates to an electronic travel information and booking system.

Conventional electronic information and booking systems for travel typically include search tools in which one can enter desirable locations for departure and arrival. A set of results is often returned in a list which may be ordered according to price. This approach is fast and effective when the traveller knows the correct names for the place of departure and the place of destination. However, the approach has limitations when a traveller is unaware of alternative travel options and is unsure of the geographical positions of the place of departure and place of destination. The list of results can also be problematic because a user needs to review each item carefully in order to find the product that best fits their requirements.

An object of the invention is to augment conventional travel information and/or booking systems by providing an alternative process for identifying and selecting locations for departure and arrival and for analysing search results. A further object of the invention is to provide a travel information system that is intuitive and geographically informative.

Electronic maps are also conventional, and these are frequently accessed by users over the internet. These electronic maps often include locations of interest such as airports, police stations, and restaurants. This information can be useful to users but it can also be overwhelming and can clutter the map, causing confusion rather than clarity. The present invention is also intended to improve users' interaction with electronic maps.

According to an aspect of the present invention there is provided an apparatus configured to display locations of interest on a map, the apparatus comprising: a display module arranged to display a map to a user; an input analysis module configured to determine the position of a movable pointer on the map; and a calculation module configured to identify any locations of interest within an area defined at least in part by the determined position of the movable pointer, wherein the display module is configured to mark on the map any locations of interest identified by the calculation module.

In this way a user can quickly determine a number of locations of interest on a map that are situated around their pointer. The pointer is movable, and, when it moves, the calculation module is preferably configured to re-assess which locations of interest are within an area defined by the new position of the pointer. Thus, as the user scans the pointer around the map they may observe a dynamically changing set of marked locations, situated around the moving pointer. It has been found that this is a particularly effective and intuitive arrangement for a user to select a departure and destination when reserving travel products.

In a preferred example the locations of interest may include airports. The user may position their pointer on the map close to a desired location for departure or arrival by airplane. The calculation module may identify a number of airports within an area centered on the position of the pointer so that the user can be visually presented with a number of alternative airports for selection. This may be useful for presenting a user with airport options that would not otherwise occur to them.

Non-limiting examples of possible locations of interest include: restaurants, train stations, hospitals, police stations, and gas stations. The principles of the invention can be applied so that a user can determine the locations for one or more of these examples on an electronic map within an area defined at least in part by the position of their pointer.

Preferably the area is defined at least in part by the determined position of the movable pointer and a predetermined radius. Thus, the calculation module may be arranged to identify locations of interest that reside within a circular area, which may be centered on the position of the movable pointer.

The predetermined radius may be chosen according to the particular requirements of the application. When applied to the airports a suitable radius may be fifty nautical miles. For restaurants, a radius of half a mile may be more appropriate.

Preferably the predetermined radius is invariant to the scale of the map. However, in some embodiments it may be desirable for the radius to be proportional to the scale of the map. Thus, a larger number of locations may be marked on the map around the pointer when the map is displayed at a large scale.

Preferably the mark on the map created by the display module is indicative of at least one property of each location of interest. In one example the mark may be indicative of properties of a restaurant such as cost, user-feedback rating, type of cuisine, and availability of tables. In another example, the mark on the map may be indicative of the size and significance of an airport. Airports may be categorized in three tiers of significance: global hubs, airports of national/regional significance, and local airports. The three categories of airport may be indicated by three colors and/or sizes of mark.

The positions of the locations of interest may be stored in a data storage unit along with other relevant information. Preferably the calculation module identifies all locations of interest from those stored in the data storage unit that have co-ordinates within an area defined in part by the position of the pointer. In some embodiments, however, it may be desirable to exclude some locations of interest from display on the map. For example, it may be desirable not to mark local airports on the map when it is viewed at a large scale because this can avoid an extreme concentration of marks on the map.

The display module may display information about each location of interest when it is selected by the user. The display information may include information about the location such as its latitude and longitude or street address. Any further information may also be displayed. The location of interest may be selected by the user moving the pointer to the relevant location on the map.

The locations of interest may include airports and the display module may be configured to display information about travel between a selected airport and a further airport. The further airport may be a default or originating airport, or some other airport that has been pre-selected by the user. The information may include, for example, the distance between the two airports, the length of the flight, the identity of airlines that operate the route, and the carbon dioxide emissions associated with the flight.

The apparatus may be a user computer configured to download at least one of the display module, the input analysis module and the calculation module from a server computer. The invention may be embodied in software modules that are stored in a server computer. These program modules may be downloaded by the user computer, over a network, preferably when the user visits a web page. Upon receipt of the program modules the user computer can display the map, monitor the position of a pointer, and mark the locations of interest. Preferably the program modules are provided in client-side JavaScript so that the modules are downloaded and run on the user computer.

Preferably a network link between the server computer and the user computer is preserved so that further data can be transferred. For example, the user computer may be arranged to download map data from the server computer, initially so that a relevant portion of the map can be displayed at a particular scale. If the user scrolls to a new portion of the map, or wishes to view the map at a different scale, data can be downloaded from the server computer accordingly. In one embodiment the server that supplies the user computer with map data may be a different server to that which supplies the user computer with program modules.

According to another aspect of the present invention there is provided a travel information system comprising: a display module arranged to display a map to a user; an input analysis module configured to determine the position of a movable pointer on the map; and a calculation module configured to identify any travel stations within an area defined at least in part by the determined position of the movable pointer, wherein the display module is configured to mark on the map any travel stations identified by the calculation module, and wherein each marked travel station is selectable by a user as an origin or destination, the system further comprising a travel determination module configured to determine routes between selected travel points on selected dates, wherein the display module is arranged to display the possible routes to a user.

The travel information system may be arranged as a flight booking system for identifying any airports within an area defined by the position of a movable pointer. Preferably the travel or flight determination module includes a network connection to at least one operator in order to acquire contemporaneous schedule and price information.

Preferably the display module is arranged to display a plurality of indicators relating to travel products for the possible routes, wherein the indicators are displayed on a graph having a first axis representative of a first property of the product, and a second axis representative of a second property of the product. The apparatus may further include a plotting module configured to plot an indicator on the graph at a position that is representative of the first and second properties of a product.

Preferably still the apparatus comprises a reservation module configured to reserve a product when the indicator for that product is selected on the graph.

It has been determined that this is a particularly effective system for presenting a user with a variety of different travel products. By presenting the products on a graph a user can quickly and conveniently appreciate the relative merits of the products.

According to another aspect of the invention there is provided a method of identifying locations of interest on a map, the method comprising the steps of: displaying a map to a user; determining the position of a movable pointer on the map; identifying any locations of interest within an area defined at least in part by the determined position of the movable pointer; and marking any identified locations of interest on the map.

According to yet another aspect of the invention there is provided a computer readable storage medium having a computer program stored thereon, the computer program comprising: a program module configured to display a map to a user; a program module configured to determine the position of a movable pointer on the map; a program module configured to identify any locations of interest within an area defined at least in part by the determined position of the movable pointer; and a program module configured to mark any identified locations of interest on the map.

The computer readable storage medium may be provided on a server computer. The server computer may be arranged to download the program modules to a user computer, over a network, so that the user computer can display the map and mark the locations of interest on the map to be viewed by a user.

According to another aspect of the invention there is provided a reservation system configured to display a plurality of indicators relating to a product, wherein the indicators are displayed on a graph having a first axis representative of a first property of the product, and a second axis representative of a second property of the product, the apparatus comprising: a plotting module configured to plot an indicator on the graph at a position that is representative of the first and second properties of a product; and a reservation module configured to reserve a product when the indicator for that product is selected on the graph.

In this way a user can be presented with options for a particular product in such a way that the user can quickly appreciate their relative merits. The comparison between products may be most striking when the properties represented in the first and second axes are numerical and continuous.

In a preferred example the reservation system is configured to reserve flights. In this example, the first axis may represent the departure time of the flight whereas the second axis may represent the cost of the flight. By plotting the flights on a graph having these axes a user may quickly be able to identify a flight that is affordable and has an acceptable departure time. The chosen flight can be reserved quickly and conveniently by selecting the appropriate indicator on the graph.

In another example relating to flights, the first axis may represent departure time and the second axis may represent return time. In this way a user may be able to identify a group of flights on the graph which have acceptable departure and return times.

The reservation system may be applied to a plurality of different product types. Non-limiting examples of products include automobiles, real estate, train tickets, hotels, and restaurant reservations. The first and second axes may be representative of appropriate properties for each of these products; for example, appropriate properties in the sale of real estate may include cost, property area, distance from city center, and number of rooms.

Preferably the plotting module is further configured to plot a feature on the graph that is representative of a third property of the product. In this way the graph may quickly enable a user to appreciate at least three properties for a product. The user may, therefore, be able quickly to identify a product that suits their requirements.

In one example the indicator plotted by the plotting module may include a characteristic that is representative of the third property. In one example the characteristic may be the color or shade of the plotted point; a color or shade index may also be plotted so that a user can check the index to determine the third property.

The plotting module may be further configured to plot features that are representative of further properties of the product.

The plotted feature may include a scale and a pointer, and the position of the pointer on the scale may be an indication of the third property of the product. Preferably the pointer appears on the scale when the indicator for the corresponding product is selected. Thus, the graph can include a single scale that can be used to indicate the third property for each plotted indicator, whenever an individual indicator is selected.

Preferably the scale is linear and situated along one side of the plotted graph. In some embodiments the scale may be plotted only when an indicator is selected by the user. In embodiments where the plotting module plots features that represent fourth and fifth properties of the product, further scales may be plotted to indicate the values of these properties.

In the preferred example, where the reservation system is for two-way flights, the first property represents departure time, the second property represents return time and the third property represents price. Thus, a user may be able to identify a flight product that has acceptable values for each of these properties.

The scale may include a colored or shaded component that assists in indicating the value of the third property. Preferably the colored or shaded component illustrates the entire range of the third property so that the full color or shade scale runs from the minimum plotted value to the maximum plotted value. The colors may be re-scaled, as appropriate, if any products are excluded from the graph, or if any further products are included.

Preferably the plotting module is configured to control whether an indicator for a product is plotted on the graph by filtering products that have a property outside an acceptable range. In this way a user can easily control the number of products that are presented on the graph. For example, the user may restrict the acceptable range of any properties, including at least one of the first and second properties, in order to filter the number of products that are displayed.

The plotting module may be arranged to control any of properties that are represented in the graph, but equally the plotting module may be arranged to filter products based on hidden properties.

The plotting module may plot a component on the graph, which component can be adjusted to control the acceptable range of at least one of the first and second properties. The plotted component may include at least one adjustable limit stop on any axes, including the first and/or second axes. In this way the user may be able to position the limit stops in order to include and exclude products, as appropriate. This may provide a convenient mechanism for the user to control the properties of products that are included in the graph.

Any axes may be re-scaled following an adjustment in the plotted products so that the entire acceptable range is displayed for the first and second properties.

According to another aspect of the invention there is provided a method of reserving a product comprising the steps of: displaying a graph having a first axis representative of a first property of a product, and a second axis representative of a second property of the product; plotting an indicator on the graph at a position that is representative of the first and second properties of a product; and reserving a product when the indicator for that product is selected on the graph.

According to yet another aspect of the invention there is provided a computer readable storage medium having a computer program stored thereon, the computer program comprising: a program module configured to display a graph having a first axis representative of a first property of a product, and a second axis representative of a second property of the product; a program module configured to plot an indicator on the graph at a position that is representative of the first and second properties of a product; and a program module configured to reserve a product when the indicator for that product is selected on the graph.

The computer readable storage medium may be provided on a server computer. The server computer may be arranged to download the program modules to a user computer, over a network, so that the user computer can display the graph and plot indicators on the graph to represent the properties of products.

Any apparatus features may be provided as method features and vice-versa.

Preferred features of the present invention will now be described, purely by way of example, with reference to the accompanying drawings, in which:

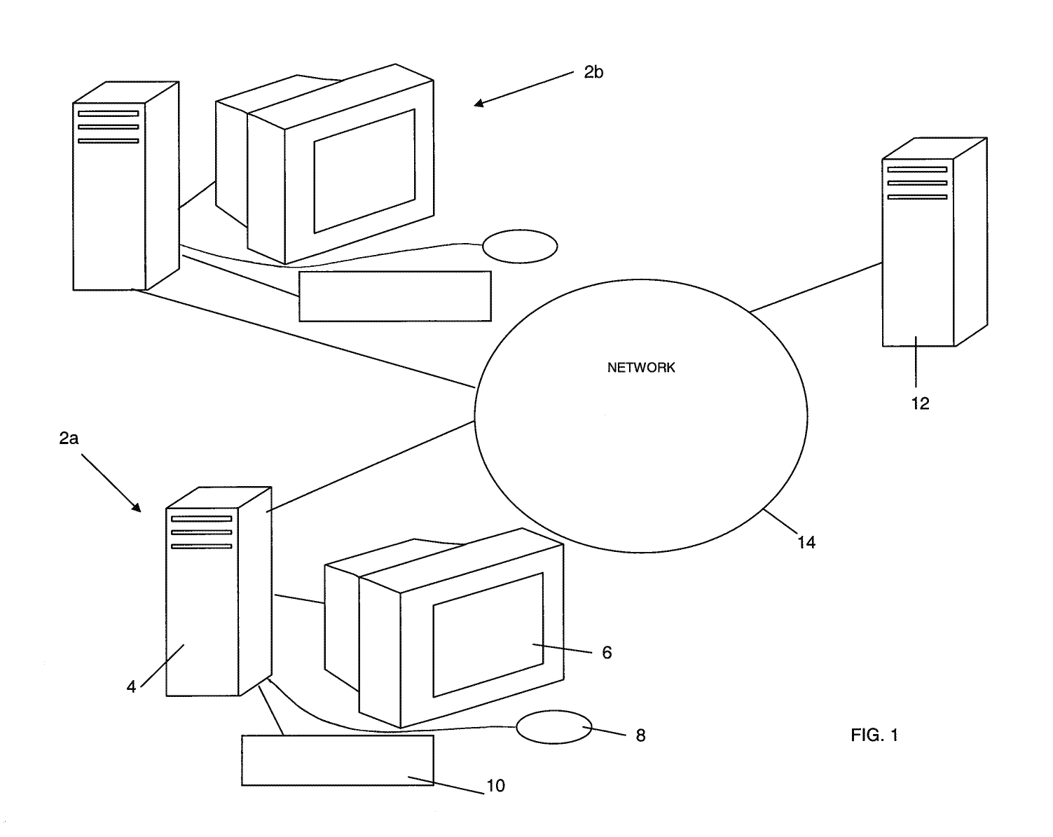

FIG. 1 is a schematic drawing of user computers communicating with a server over a network;

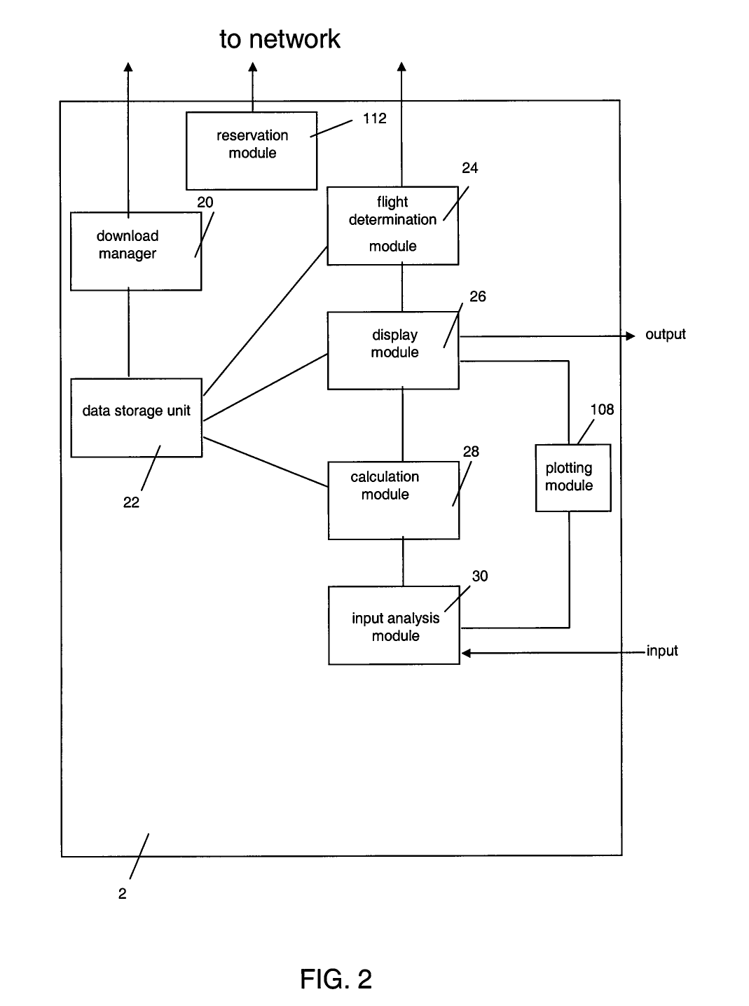

FIG. 2 shows functional blocks of a user computer in an embodiment of the invention;

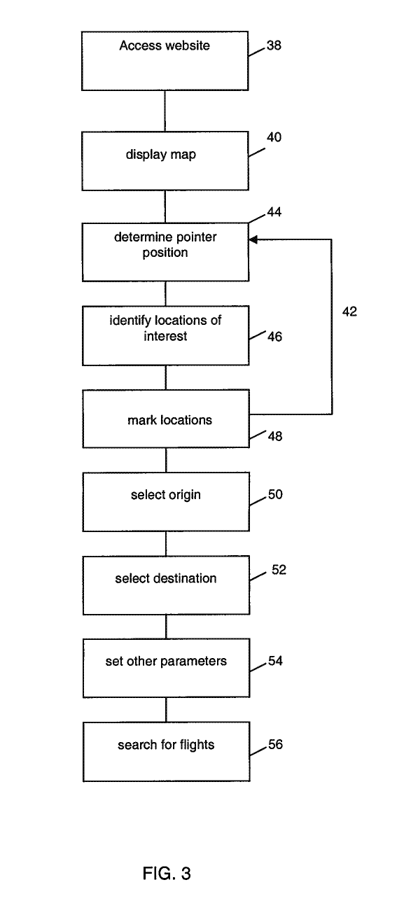

FIG. 3 is a flow diagram showing a sequence of steps that may be undertaken by a user computer in an embodiment of the invention;

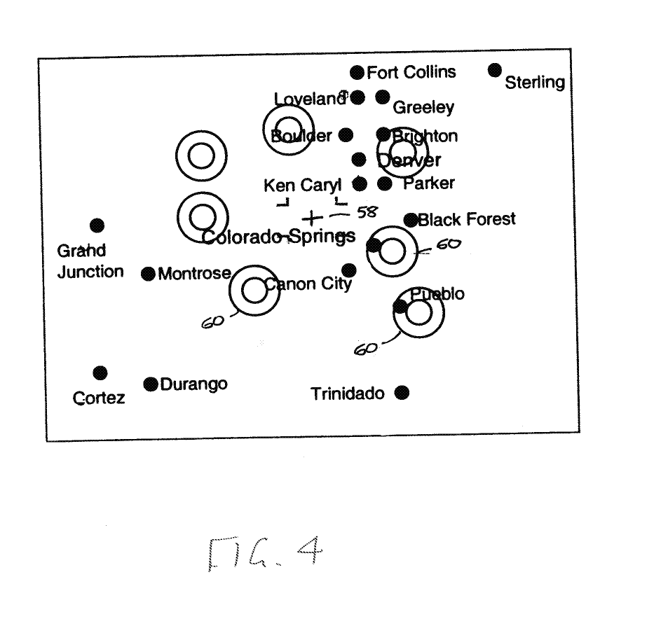

FIG. 4 shows an example of a map created by a user computer in an embodiment of the invention;

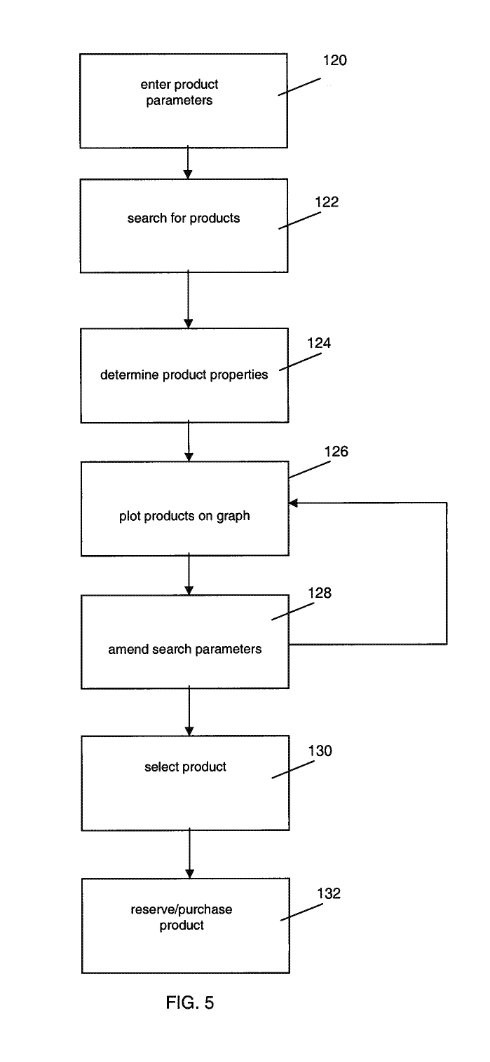

FIG. 5 is a flow diagram showing a sequence of steps to be undertaken in an embodiment of the invention; and

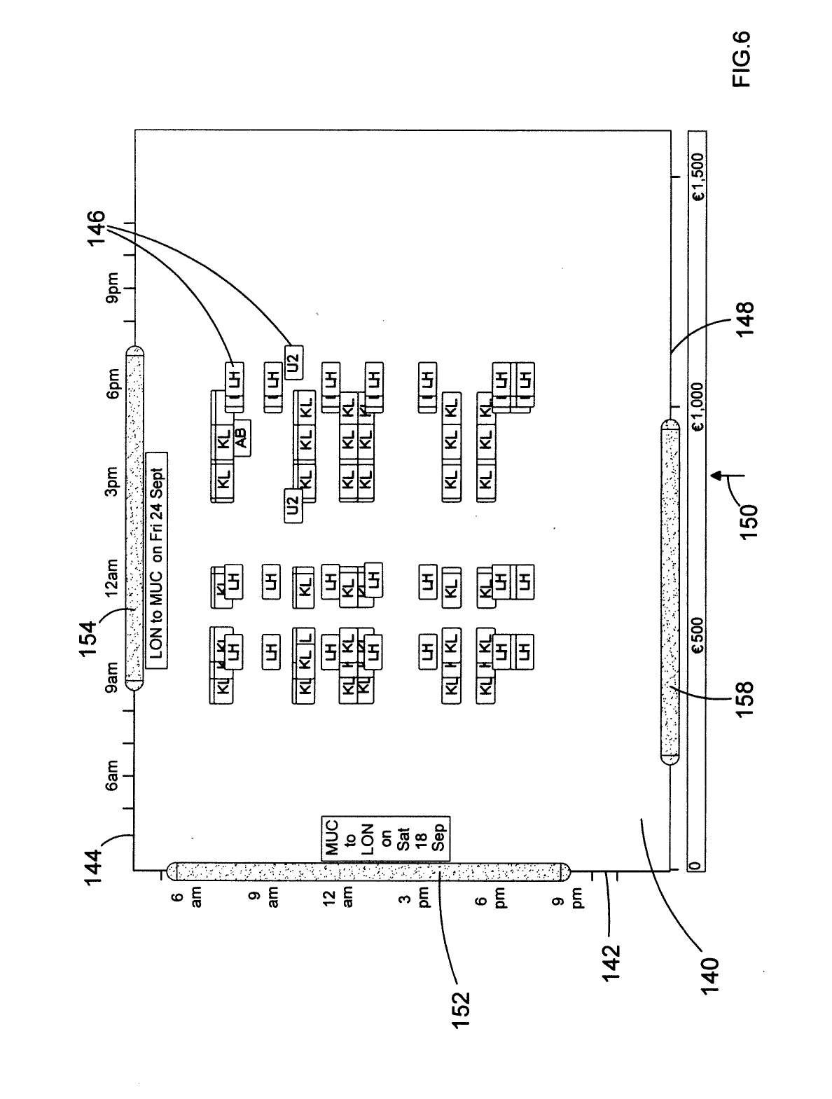

FIG. 6 shows an example of a graph that has been produced by a reservation system in an embodiment of the invention.

FIG. 1 is a schematic diagram showing user computers 2a, 2b communicating with a server 12 over a network 14. The user computers 2a, 2b include a control unit 4, a visual display unit 6, a mouse 8, and a keyboard 10.

The server 12 supports a website that can be accessed by any of the user computers 2a, 2b. The server 12 is arranged to supply the user computers 2a, 2b with program modules in client-side JavaScript whenever the user computers access the website. These program modules are downloaded to the user computers 2a, 2b so that the modules can run on the user computers.

FIG. 2 shows the functional components of a user computer 2 with program modules that have been downloaded from the server 12. The user computer 2 comprises a download manager 20 which is arranged to communicate with the server 12, and manage downloads. A data storage unit 22 stores any relevant data including data downloaded from the server 12. The downloaded program modules include a flight determination module 24, a display module 26, a calculation module 28, an input analysis module 30, a plotting module 108, and a reservation module 112.

The operation of the program modules may be understood readily with reference to FIG. 3 which is a flow diagram illustrating a sequence of steps to be undertaken by the user computer 2. At step 38 a user accesses a website using the computer 2, and this initiates communication between the computer 2 and the server 12. The server 12 is arranged to send program modules to the user computer 2 when communication is initiated; the program modules are received initially by the download manager 20 and stored in memory, which may mean the data storage unit 22, or some other memory resource. The download manager 20 also receives a set of supporting data files from the server 12, and these are stored in the data storage unit 22. The supporting data files include electronic map data and the co-ordinates of locations of interest which in this example means the co-ordinates for airports. In some embodiments a portion of the supporting data files, such as the map data, may be downloaded from a third party server, over the network 14.

At step 40 the display module 26 is arranged to display a map by outputting data to the visual display unit 6. The map data are stored in the data storage unit 22 for a particular scale, centered on a particular location. If the user requires a different scale of map or wishes to center the map on a new location further map data can be downloaded from the server 12 (or a third party server).

At step 44 the input analysis module 30 is arranged to detect the position of a user-controlled pointer on the map. The input analysis module 30 receives an input from the mouse 8 and monitors the co-ordinates of the associated pointer, as displayed on the electronic map.

At step 46 the calculation module 28 determines a circular area, centered on the position of the pointer, using a predetermined radius that is stored in the data storage unit 22. The calculation module 28 applies a filter to the list of locations stored in the data storage unit 22 so that any locations with co-ordinates inside the circular area are identified. At step 48 the display module 26 marks the identified locations on the electronic map which is displayed to the user.

The calculation module 28 may perform a variety of alternative calculations, depending on settings that may be controlled by a user. For example, the calculated area may be non-circular and may not be centered on the position of the pointer. In one example, the area could be a square with the pointer positioned at one of the vertices. A variety of considerations may also contribute to the construction of the filter applied by the calculation module 28. For example, an airport may have co-ordinates that are within the area determined by the calculation module 28, but the airport may be excluded by the filter if it lies across a national border or across a body of water with respect to the pointer.

Steps 44, 46 and 48 operate in a cycle 42 because the position of the pointer is continuously variable by the user. Thus, when the pointer moves to a new position the calculation module 28 can determine a new area centered on the new position of the pointer. The calculation module 28 can then identify a new set of locations from those stored in the data storage unit 22, and these new locations can be marked on the map by the display module 26. In this way, a user may observe a dynamically changing display showing different locations of interest marked around the pointer as it moves on the electronic map.

FIG. 4 shows an example of a map that is output by the display module 26 showing the state of Colorado. The map includes a user pointer 58 which can move freely. Various airports 60 are shown on the map around the pointer 58. In this example the calculation module 28 has calculated a circular area with a radius of fifty nautical miles, centered on the position of the pointer 58. Any airports 60 within the calculated area are marked on the map by the display module 24. In some embodiments the color and size of the mark on the map may be indicative of the size and significance of an airport from one of global hub, airport of national/regional significance, and local airport.

The pointer 58 is movable and its position is continuously tracked by the input analysis module 30. Thus, with reference to FIG. 4, if user were to move the pointer 58 south and west, Denver airport would no longer be marked whereas a new mark would appear for Montrose airport.

At step 50 the user can select a marked airport on the map as a point of departure. At step 52 the user can select a second marked airport as a point of destination. Either of these steps may be replaced by the user entering the name of their chosen airport, if they know this information already.

The display module 26 is configured to display information about each marked airport when it is selected by the user, including the name of the airport and its latitude and longitude. When a second marked airport is selected the display module 26 is configured to display information about travel between the selected airports including the distance between the two airports, the length of the flight, the identity of airlines that operate between the airports, and the carbon dioxide emissions associated with the flight.

At step 54 the user can enter various parameters for the flight they require. For example, the user can specify travel dates, that they are only interested in direct flights, or that they are not interested in flights above a certain price.

At step 56 the flight determination module 24 performs a search for flights that match the user's chosen airports and additional criteria. The search is actually performed by sending a request to the server 12. A set of results is accumulated by the server 12 and sent to the computer 2 for display by the display module 26. A user can then select and reserve any of the displayed flights.

FIG. 5 is a flow diagram showing a sequence of steps to be undertaken by user computer program modules when displaying the set of matching flights.

At step 120 the user can enter the parameters of a particular flight that they require, including an origin and destination along with possible outward and return dates. In a particularly preferred embodiment the user can enter the origin and destination for a flight by selecting marked airports on the electronic map at steps 50 and 52.

At step 122 the flight determination module 24 searches for possible products that match the search parameters. The flight determination module 24 can examine products that are stored in the data storage unit 102 and it can also forward the search parameters to the server 12 so that it can undertake a further search. In one arrangement the server 12 may acquire data directly from flight operators. The flight determination module 24 outputs a set of possible products and, at step 124, it determines a set of properties for each product. In a preferred example the flight determination module 24 determines the outbound time and date of a two-way flight product, the inbound time and date, and the price.

At step 126 the plotting module 106 plots the set of products determined by the flight determination module 24 in a graph, and the graph is output to the user by the display module 26. FIG. 6 shows an example of a graph 140 that is produced by the plotting module 106, showing a set of flight products from London to Munich. The graph includes a first axis 142 that represents the outward flight departure time and a second axis 144 that represents the return flight departure time. The plotting module 106 plots an indication 146 for each flight on the graph at a position corresponding to the flight's outward and return times; each indication includes a two-letter code representing the flight operator. The graph 140 is output to the visual display unit 6 by the display module 26, and in this way the graph 140 provides a visual indication of products that match the user's search parameters.

The plotting module 106 also plots a linear scale 148 along one of the graph's axes in order to represent price. A pointer 150 indicates the price for a product when the appropriate product indication 146 is selected in the graph. In addition the scale is shaded and the full range of shading runs from zero to the maximum price of a product in the set of results.

At step 128 the user can alter the properties of the graph 140. In particular, the axes 142, 144 of the graph and the linear scale 148 each include adjustable bars 152, 154, 158. The adjustable bars 152, 154, 158 can be translated, shortened and lengthened in order to adjust the parameters of the products that are included in the graph. Thus, the adjustable bars 152, 154, 158 provide an intuitive mechanism for amending and updating the parameters of the original product search. Any adjustment of the adjustable bars 152, 154, 158 is detected by the input analysis module 30 and communicated to the plotting module 108.

If a user makes any alteration at step 128, the plotting module 108 re-plots the graph 140 at step 126 in order to show an amended set of products. The plotting module 108 also re-scales the graph following any adjustment so that the full adjusted range is displayed with an appropriate color scale.

At step 130 the user selects an indication 146 from the graph corresponding to a product they would like to reserve, and this selection is detected by the input analysis module 30. At step 132 the reservation module 112 performs a sequence of steps (not shown) that allow the product to be purchased or reserved.

The graph 140 is not only applicable to the reservation of flights. It can equally be applied to the reservation and/or purchase of other products, non-limiting examples of which include automobiles, real estate, train tickets, and hotel rooms.

1. An apparatus configured to display locations of interest on a map, the apparatus comprising:
a display module arranged to display a map to a user;
an input analysis module configured to determine the position of a movable pointer on the map; and
a calculation module configured to identify any locations of interest within an area defined at least in part by the determined position of the movable pointer,
wherein the display module is configured to mark on the map any locations of interest identified by the calculation module.

2. The apparatus of claim 1 wherein the area is defined at least in part by the determined position of the movable pointer and a predetermined radius.

3. The apparatus of claim 1 wherein the mark on the map created by the display module is indicative of at least one property of each location of interest.

4. The apparatus of claim 1 wherein the display module is configured to display information about each location of interest when it is selected by the user.

5. The apparatus of claim 4 wherein the locations of interest include airports and the display module is configured to display information about travel between a selected airport and a further airport.

6. The apparatus of claim 1, wherein the apparatus is a user computer configured to download at least one of the display module, the input analysis module and the calculation module from a server computer.

7. An information system comprising:
a display module arranged to display a map to a user;
an input analysis module configured to determine the position of a movable pointer on the map; and
a calculation module configured to identify any travel stations within an area defined at least in part by the determined position of the movable pointer,
wherein the display module is configured to mark on the map any travel stations identified by the calculation module, and wherein each marked travel station is selectable by a user as an origin or destination,
the system further comprising a travel determination module configured to determine routes between selected travel points on selected dates, wherein the display module is arranged to display the possible routes to a user.

8. The information system of claim 7 wherein the display module is arranged to display a plurality of indicators relating to travel products for the possible routes, wherein the indicators are displayed on a graph having a first axis representative of a first property of the product, and a second axis representative of a second property of the product, and wherein the apparatus further comprises a plotting module configured to plot an indicator on the graph at a position that is representative of the first and second properties of a product.

9. The information system of claim 8 further comprising a reservation module configured to reserve a product when the indicator for that product is selected on the graph.

10. A method of identifying locations of interest on a map, the method comprising the steps of:
displaying a map to a user;
determining the position of a movable pointer on the map;
identifying any locations of interest within an area defined at least in part by the determined position of the movable pointer; and
marking any identified locations of interest on the map.

11. A computer readable storage medium having a computer program stored thereon, the computer program comprising:
a program module configured to display a map to a user;
a program module configured to determine the position of a movable pointer on the map;
a program module configured to identify any locations of interest within an area defined at least in part by the determined position of the movable pointer; and
a program module configured to mark any identified locations of interest on the map.

12. A reservation system configured to display a plurality of indicators relating to a product, wherein the indicators are displayed on a graph having a first axis representative of a first property of the product, and a second axis representative of a second property of the product, the apparatus comprising:
a plotting module configured to plot an indicator on the graph at a position that is representative of the first and second properties of a product; and
a reservation module configured to reserve a product when the indicator for that product is selected on the graph.

13. The reservation system of claim 12 wherein the plotting module is further configured to plot a feature on the graph that is representative of a third property of the product.

14. The reservation system of claim 12 wherein the plotted feature includes a scale and a pointer, and the position of the pointer on the scale is an indication of the third property of the product.

15. The reservation system of claim 12 wherein the plotting module is configured to control whether an indicator for a product is plotted by filtering products that have a property outside an acceptable range.

16. The reservation system of claim 15 wherein the plotting module plots a component on the graph and can be adjusted to control the acceptable range of at least one of the first and second properties.

17. The reservation system of claim 15 wherein the first and/or second axes are re-scaled following an adjustment in the plotted products so that the entire acceptable range is displayed for the first and second properties.

18. A method of reserving a product comprising the steps of:
displaying a graph having a first axis representative of a first property of a product, and a second axis representative of a second property of the product;
plotting an indicator on the graph at a position that is representative of the first and second properties of a product; and
reserving a product when the indicator for that product is selected on the graph.

19. A computer readable storage medium having a computer program stored thereon, the computer program comprising:
a program module configured to display a graph having a first axis representative of a first property of a product, and a second axis representative of a second property of the product;
a program module configured to plot an indicator on the graph at a position that is representative of the first and second properties of a product; and
a program module configured to reserve a product when the indicator for that product is selected on the graph.
